(19) United States
(12) Patent Application Publication
(10) Pub. No.: US 2022/0361237 A1
(43) Pub. Date: Nov. 10, 2022

(54) Radio Network Node, User Equipment (UE) and Methods Performed in a Wireless Communication Network

(71) Applicant: Telefonaktiebolaget LM Ericsson (publ), Stockholm (SE)

(72) Inventors: Björn Hofström, Linköping (SE); Jonas Sedin, Sollentuna (SE); Helka-Liina Määttänen, Helsinki (FI); Xingqin Lin, San Jose, CA (US)

(21) Appl. No.: 17/764,580

(22) PCT Filed: Sep. 29, 2020
(86) PCT No.: PCT/SE2020/050912

§ 371 Date: Mar. 29, 2022

Related U.S. Application Data
(60) Provisional application No. 62/909,799, filed on Oct. 3, 2019.

(51) Int. Cl. H04W 74/00; H04L 5/00; H04W 52/02; H04W 72/12

(52) U.S. Cl. CPC H04W 74/006; H04L 5/0078; H04L 5/0053; H04W 52/0229; H04W 72/1289

(57) ABSTRACT

Embodiments herein relate e.g. to a method performed by a UE (10) for managing monitoring of a control channel for transmissions from a radio network node (12). The UE activates, upon detection of a triggering event occurrence, a timer, wherein the triggering event occurrence comprises transmitting a scheduling request and/or receiving a RAR. The UE further initiates, upon expiry of the timer, a monitoring of a control channel for one or more transmissions from the radio network node.

### TECHNICAL FIELD

Embodiments herein relate to a radio network node, a user equipment (UE) and methods performed therein regarding wireless communication. Furthermore, a computer program product and a computer-readable storage medium are also provided herein. Especially, embodiments herein relate to handling or enabling communication, e.g. handling access or use of scheduled resources such as frequency and/or time, between the radio network node and the UE in a wireless communication network.

### BACKGROUND

In a typical wireless communication network, UEs, also known as wireless communication devices, mobile stations, stations (STA) and/or wireless devices, communicate via a Radio access Network (RAN) to one or more core networks (CN). The RAN covers a geographical area which is divided into service areas or cell areas, with each service area or cell area being served by a radio network node such as an access node e.g. a Wi-Fi access point or a radio base station (RBS), which in some radio access technologies (RAT) may also be called, for example, a NodeB, an evolved NodeB (eNodeB) and a gNodeB (gNB). The service area or cell area is a geographical area where radio coverage is provided by the radio network node. The radio network node operates on radio frequencies to communicate over an air interface with the wireless devices within range of the access node. The radio network node communicates over a downlink (DL) to the wireless device and the wireless device communicates over an uplink (UL) to the access node.

A Universal Mobile Telecommunications System (UMTS) is a third generation telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with user equipments. In a forum known as the Third Generation Partnership Project (3GPP), telecommunications suppliers propose and agree upon standards for present and future generation networks and UTRAN specifically, and investigate enhanced data rate and radio capacity. In some RANs, e.g. as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. The RNCs are typically connected to one or more core networks.

Specifications for the Evolved Packet System (EPS) have been completed within the 3^{rd} Generation Partnership Project (3GPP) and this work continues in the coming 3GPP releases, such as 4G and 5G networks. The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the Radio Access Network (RAN) of an EPS has an essentially “flat” architecture comprising radio network nodes connected directly to one or more core networks.

With the emerging 5G technologies also known as new radio NR, the use of very many transmit- and receive-antenna elements is of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions.

Beamforming allows the signal to be stronger for an individual connection. On the transmit-side this may be achieved by a concentration of the transmitted power in the desired direction(s), and on the receive-side this may be achieved by an increased receiver sensitivity in the desired direction(s). This beamforming enhances throughput and coverage of the connection. It also allows reducing the interference from unwanted signals, thereby enabling several simultaneous transmissions over multiple individual connections using the same resources in the time-frequency grid, so-called multi-user Multiple Input Multiple Output (MIMO).

There is an ongoing resurgence of satellite communications. Several plans for satellite networks have been announced in the past few years. The target services vary, from backhaul and fixed wireless, to transportation, to outdoor mobile, to internet of things (IoT). Satellite networks could complement mobile networks on the ground by providing connectivity to underserved areas and multicast/broadcast services.

To benefit from the strong mobile ecosystem and economy of scale, adapting the terrestrial wireless access technologies including LTE and NR for satellite networks is drawing significant interest. For example, 3GPP completed an initial study in Release (Rel) 15 on adapting NR to support non-terrestrial networks (mainly satellite networks). This initial study focused on the channel model for the non-terrestrial networks, defining deployment scenarios, and identifying the key potential impacts. 3GPP is conducting a follow-up study item in Release 16 on solutions evaluation for NR to support non-terrestrial networks, see e.g. RP-181370 “Study on solutions evaluation for NR to support non-terrestrial Network”.

### Satellite Communications

A satellite radio access network usually includes the following components:
Gateway that connects satellite network to core network
Satellite that refers to a space-borne platform
Terminal that refers to user equipment
Feeder link that refers to the link between a gateway and a satellite
Service link that refers to the link between a satellite and a terminal

The link from gateway to terminal is often called forward link, and the link from terminal to gateway is often called return link. Depending on the functionality of the satellite in the system, we can consider two transponder options
Bent pipe transponder: satellite forwards the received signal back to the earth with only amplification and a shift from uplink frequency to downlink frequency.
Regenerative transponder: satellite includes on-board processing to demodulate and decode the received signal and regenerate the signal before sending it back to the earth.

Depending on the orbit altitude, a satellite may be categorized as LEO, MEO, or GEO satellite.
LEO: typical heights ranging from 250-1,500 km, with orbital periods ranging from 90-130 minutes.
MEO: typical heights ranging from 5,000-25,000 km, with orbital periods ranging from 2-14 hours.
GEO: typical height is about 35,786 km, with an orbital period of 24 hours.

### Propagation Delays.

A propagation delay is a main physical phenomenon in a satellite communication system that makes the design different from that of a terrestrial mobile system. The following Tables 1 and 2 have shown some typical values for the propagation delay for some different altitudes and architectures. For example, it is about 545 ms for a GEO satellite system. In contrast, the round-trip time is normally no more than 1 ms for typical terrestrial cellular networks.

TABLE 1
Propagation delays for GEO satellite at 35,786 km

| GEO at 35786 km | | |
|---|---|---|
| Path | D (km) | Time (ms) |

Bent Pipe satellite

| | | | |
|---|---|---|---|
| One way delay | Gateway-satellite-UE | 81712.6 | 272.375 |
| Round trip Time | Twice | 163425.3 | 544.751 |

Regenerative Satellite

| | | | |
|---|---|---|---|
| One way delay | Satellite-UE | 40586 | 135.286 |
| Round Trip Time | Satellite-UE-Satellite | 81172 | 270.572 |

TABLE 2
Propagation delays for NGSO satellites

| | LEO at 600 km | | LEO at 1500 km | | MEO at 10000 km | |
|---|---|---|---|---|---|---|
| | Distance | Delay | Distance | Delay | Distance | Delay |
| Path | D (km) | (ms) | D (km) | (ms) | D (km) | (ms) |

Bent pipe satellite

| | | | | | | | |
|---|---|---|---|---|---|---|---|
| One way | Gateway- | 4261.2 | 14.204 | 7749.2 | 25.83 | 28557.6 | 95.192 |
| delay | satellite UE | | | | | | |
| Round | Twice | 8522.5 | 28.408 | 15498.4 | 51.661 | 57115.2 | 190.38 |
| Trip | | | | | | | |
| Delay | | | | | | | |

Regenerative satellite

| | | | | | | | |
|---|---|---|---|---|---|---|---|
| One way | Satellite-UE | 1932.24 | 6.44 | 3647.5 | 12.16 | 14018.16 | 46.73 |
| delay | | | | | | | |
| Round | Satellite-UE- | 3864.48 | 12.88 | 7295 | 24.32 | 28036.32 | 93.45 |
| Trip | Satellite | | | | | | |
| Delay | | | | | | | |

A scheduling request (SR) is a one-bit indicator to request uplink resources for new transmissions. It allows the UE to indicate to the radio network node that the UE has data in the buffer. After the network, i.e. the radio network node, receives the scheduling request from the UE the network will be aware that the UE needs uplink resources and can therefore schedule the UE.

The scheduling request is triggered whenever the UE has new data in its buffers but no uplink resources. One example where this might happen is for instance after random access. At this point the UE may might be properly synched but have not received any uplink resources.

When the UE has sent an SR, it initiates a counter denoted as SR_COUNTER and sets the value to zero and starts a timer denoted as sr-ProhibitTimer to avoid sending repeated SRs before the network (NW) have had a chance to respond. If no assignment is received on the physical downlink control channel (PDCCH) during this time, the UE sends a new SR, increases or increments the SR_COUNTER and restarts the sr-ProhibitTimer. If no assignment is received, this process is repeated until the SR_COUNTER equals a preconfigured value of sr-TransMax. If sr-TransMax is reached, the UE initiates the Random Access procedure to acquire the UL resources needed. To make sure the UE is monitoring a PDCCH for a response to the SR, the UE will be in active time after sending the SR and shall thus will monitor the PDCCH continuously during this procedure.

### Contention Free Random Access

When Contention Free Random Access (CFRA) is performed, typically during Handover (HO), the UE receives a radio resource control (RRC)-reconfiguration message from the source radio network node, which includes the RRC configuration for the target radio network node. When the UE receives this message, it will typically discard the RRC configuration for the source radio network node and apply the RRC configuration for the target radio network node. Since contention free access is used the UE will not start a timer denoted as the ra-contentionResolutionTimer to activate the monitoring of the PDCCH. Therefore, the UE is expected to be in active time at this stage to enable continuous monitoring of the PDCCH.

Besides CFRA, the UE may transmit a Random Access Preamble not selected by the media access control (MAC) entity among the contention-based Random Access Preambles, e.g., PDCCH ordered random access and beam failure recovery triggered random access.

### Discontinuous Reception (DRX) Operation

NR DRX operation is described in Clause 5.7 in TS 38.321 v.15.5.0. According to Clause 5.7 in TS 38.321 v.15.5.0, the MAC entity may be configured by RRC with a DRX functionality that controls the UE's PDCCH monitoring activity.

When a DRX cycle is configured, the Active Time includes the time while:
drx-onDurationTimer or drx-InactivityTimer or drx-RetransmissionTimerDL or drx-RetransmissionTimerUL or ra-ContentionResolutionTimer (as described in subclause 5.1.5) is running; or
a Scheduling Request is sent on physical uplink control channel (PUCCH) and is pending (as described in subclause 5.4.4); or
a PDCCH indicating a new transmission addressed to the cell random network temporary identifier (C-RNTI) of the MAC entity has not been received after successful reception of a Random Access Response for the Random Access Preamble not selected by the MAC entity among the contention-based Random Access Preamble (as described in 5.1.4).

When DRX has been configured and the UE is in active time, it monitors the DL PDCCH continuously. During the active time, the network knows that the UE is reachable and will send scheduling assignments or uplink grants when needed. The active time of the UE is mainly controlled by timers configured when DRX is configured by the use of RRC signaling, see e.g. FIG. 1. But, some active time is triggered upon actions initiated by the UE, see above. For example, when the UE sends a Scheduling request on PUCCH, the UE will remain active as long as it has an SR request pending.

Also, the UE will enter active time after successful reception of a Random Access Response (RAR) for the Random Access (RA) Preamble not selected by the MAC entity among the contention-based Random Access Preamble.

### SUMMARY

Main issues with the existing DRX protocol for large propagation delays may e.g. be:
Case 1: When the UE sends as Scheduling Request or has one pending, it will start monitoring the PDCCH continuously for a response. With the current value range of sr-ProhibitTimer and sr-TransMax, the UE can be kept in active time for several round trip times (RTT). But, given the large propagation delays in a non-terrestrial system the response will not arrive until at least a duration of RTT has elapsed and during this time the UE will monitor the PDCCH in vain, wasting energy and thus decreasing battery lifetime.
Case 2: When the UE has successfully received a Random Access Response for the Random Access Preamble not selected by the MAC entity among the contention-based Random Access Preamble, it will enter active time and start continuous monitoring of the PDCCH. Given that the physical uplink shared channel (PUSCH) scheduled by the RAR grant in this case acts as acknowledgement (ACK) for the RAR, the NW typically does not transmit new PDCCH until it has received the PUSCH scheduled by the RAR grant. From the UE's perspective, given the large RTT, the UE will need to monitor the PDCCH in vain during the first RTT (plus time offset between the reception of the RAR and the transmission of the PUSCH scheduled by the RAR).

FIG. 2 shows how the UE needs to continuously monitor PDCCH when it is not possible for the UE to receive a reply.

In short, the existing procedure for UE triggered active time is optimized for terrestrial networks. In non-terrestrial networks, where the propagation delay is large, the UE will waste energy by monitoring the PDCCH when nothing can be received due to the long propagation delay. In some satellite networks, the RTT may be up to 600 ms, which would mean that the UE would have monitored the PDCCH for more than half a second during which there will be no PDCCH transmission from the network.

An object of embodiments herein is to provide a mechanism that improves energy efficiency in the wireless communication network.

According to one aspect, the object is achieved by providing a method performed by a UE for managing monitoring of a control channel from the radio network node. The UE activates, upon detection of a triggering event occurrence, a timer, wherein the triggering event occurrence comprises transmitting a scheduling request, receiving a RAR, sending a physical uplink shared channel (PUSCH) message scheduled by a RAR grant. The UE initiates, upon expiry of the timer, a monitoring of a control channel for one or more transmissions from the radio network node.—

According to another aspect, the object is achieved by providing a method performed by a radio network node for handling monitoring of a control channel in a wireless communication network, e.g. managing monitoring of the UE for transmissions from the radio network node. The radio network node transmits a configuration for configuring the UE to apply a timer, e.g. a first or a second timer, upon knowledge of RTT between the radio network node and the UE. The configuration indicates a value of the timer, a timer to use and/or the RTT between the radio network node and the UE. Thus, the radio network node may transmit an indication to the UE, wherein the indication indicates a value of the timer and/or RTT between the radio network node and the UE.

According to still another aspect the object is achieved by providing a UE for managing monitoring of a control channel from a radio network node. The UE is configured to activate, upon detection of a triggering event occurrence, a timer, wherein the triggering event occurrence comprises transmitting a scheduling request, receiving a RAR, sending a PUSCH message scheduled by a RAR grant. The UE is further configured to initiate, upon expiry of the timer, a monitoring of a control channel for one or more transmissions from the radio network node. For example, during the timer the UE may not be allowed to monitor the control channel for one or more transmissions from the radio network node. In other words, the UE is configured to, upon detection of a triggering event occurrence, activate a timer and upon expiry of the timer the UE is configured to monitor a control channel for one or more transmissions from the radio network node.

According to yet another aspect the object is achieved by providing a radio network node for handling monitoring of a control channel in a wireless communication network. The radio network node is configured to transmit a configuration for configuring a UE to apply a timer, e.g. a first or a second timer, upon knowledge of RTT between the radio network node and the UE. The configuration indicates a value of the timer, a timer to use and/or the RTT between the radio network node and the UE. Thus, the radio network node may be configured to transmit an indication to the UE, wherein the indication indicates a value of the timer and/or RTT between the radio network node and the UE.

It is furthermore provided herein a computer program product comprising instructions, which, when executed on at least one processor, cause the at least one processor to carry out any of the methods above, as performed by the radio network node, or the UE, respectively. It is additionally provided herein a computer-readable storage medium, having stored thereon a computer program product comprising instructions which, when executed on at least one processor, cause the at least one processor to carry out the method according to any of the methods above, as performed by the radio network node, or the UE, respectively.

It is herein disclosed a UE and a radio network node configuring the UE for control channel monitoring to account for large propagation delays and still be as energy efficient as possible. Embodiments herein may introduce options to allow the UE to monitor the PDCCH discontinuously when the propagation delay in the system is large. This allows the UE to save energy and the battery lifetime can be extended, thus, improving energy efficiency in the wireless communication network.

### BRIEF DESCRIPTION OF THE DRAWINGS

Embodiments will now be described in more detail in relation to the enclosed drawings, in which:

FIG. 1 is a schematic overview depicting timers and duration for monitoring a control channel according to prior art;

FIG. 2 is a schematic overview of the resource request procedure between the UE and the radio network node;

FIG. 3 is a schematic overview depicting a wireless communication network according to embodiments herein;

FIG. 4a is a combined signalling scheme and flowchart according to embodiments herein;

FIG. 4b is a flowchart depicting a method performed by a UE according to embodiments herein;

FIG. 4c is a flowchart depicting a method performed by a radio network node according to embodiments herein;

FIG. 5a are schematic overviews of communication between the radio network node and the UE;

FIG. 5b is a block diagram depicting a UE according to embodiments herein;

FIG. 5c is a block diagram depicting a radio network node according to embodiments herein;

FIG. 6 schematically illustrates a telecommunication network connected via an intermediate network to a host computer;

FIG. 7 is a generalized block diagram of a host computer communicating via a base station with a user equipment over a partially wireless connection; and

FIGS. 8-11 are flowcharts illustrating methods implemented in a communication system including a host computer, a base station and a user equipment.

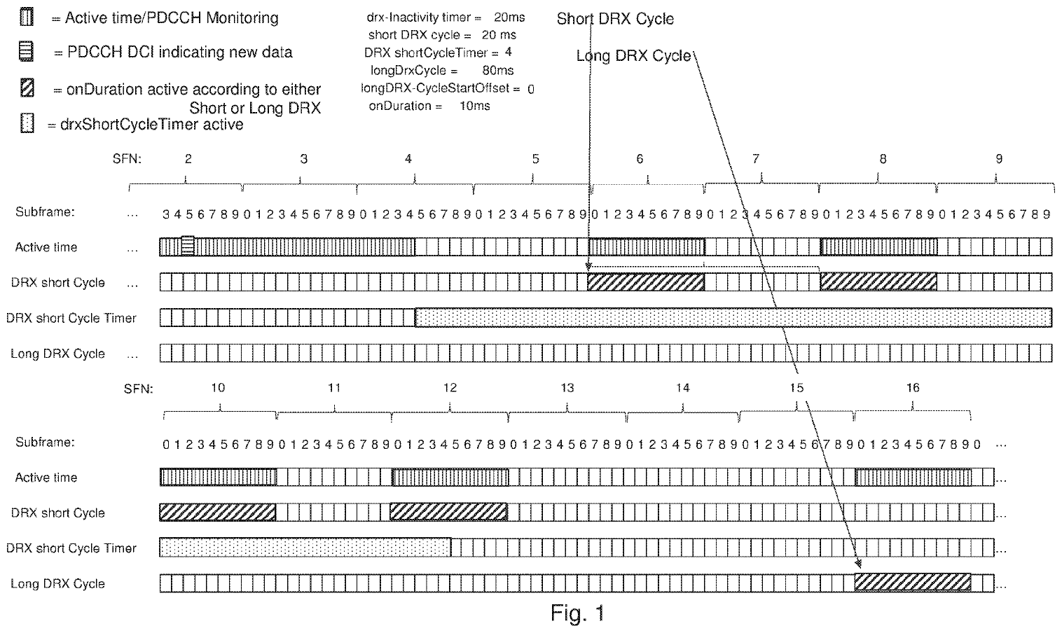

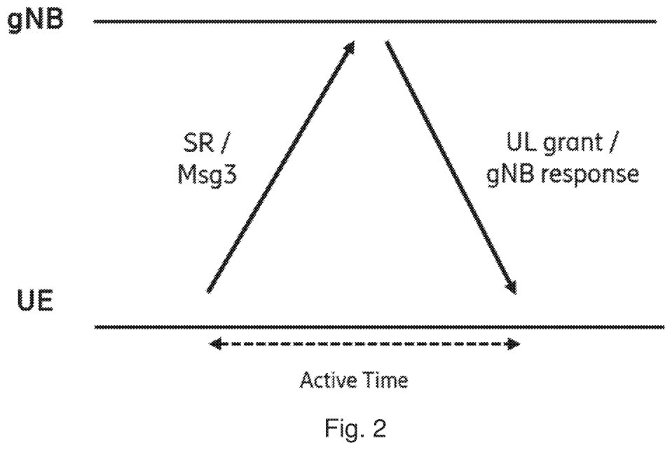

### DETAILED DESCRIPTION

Embodiments herein may be described within the context of 3GPP NR radio technology (3GPP TS 38.300 V15.2.0 (2018-06)), e.g. using gNB as the radio network node. It is understood, that the problems and solutions described herein are equally applicable to wireless access networks and user-equipments (UEs) implementing other access technologies and standards. NR is used as an example technology where embodiments are suitable, and using NR in the description therefore is particularly useful for understanding the problem and solutions solving the problem. In particular, embodiments are applicable also to 3GPP LTE, or 3GPP LTE and NR integration, also denoted as non-standalone NR.

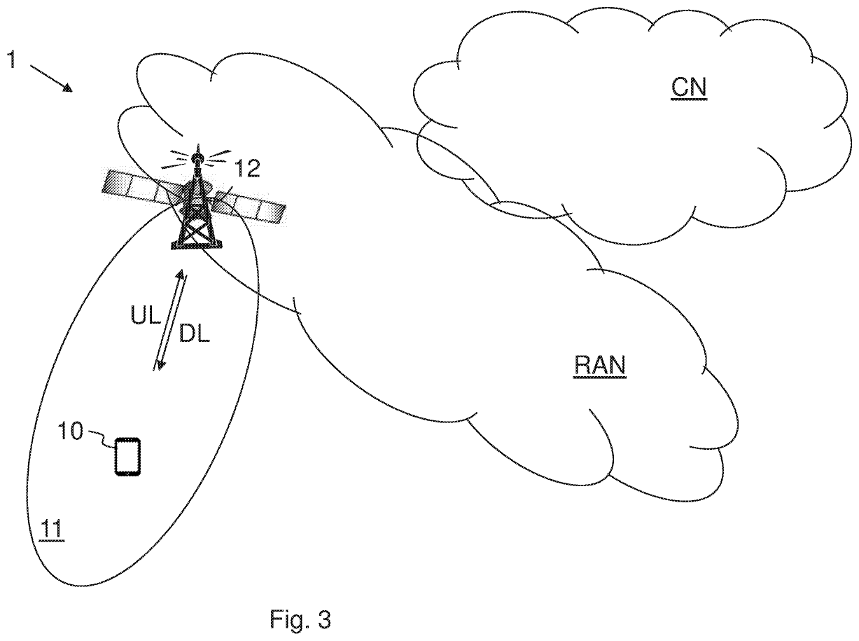

Embodiments herein relate to wireless communication networks in general. FIG. 3 is a schematic overview depicting a wireless communication network 1. The wireless communication network 1 comprises one or more RANs and one or more CNs. The wireless communication network 1 may use one or a number of different technologies, such as a satellite communication system (LEO, GEO, MEO), Wi-Fi, Long Term Evolution (LTE), LTE-Advanced, Fifth Generation (5G), Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in satellite communication system, however, embodiments are also applicable in further development of the existing wireless communication systems such as e.g. a 5G, WCDMA and LTE.

In the wireless communication network 1, wireless devices e.g. a UE 10 such as a mobile station, a non-access point (non-AP) STA, an STA, a user equipment and/or a wireless terminal, communicate via one or more Access Networks (AN), e.g. RAN, to one or more core networks (CN). It should be understood by the skilled in the art that “UE” is a non-limiting term which means any terminal, wireless communication terminal, user equipment, Machine Type Communication (MTC) device, Device to Device (D2D) terminal, IoT operable device, or node e.g. smart phone, laptop, mobile phone, sensor, relay, mobile tablets or even a small base station capable of communicating using radio communication with a radio network node within an area served by the radio network node.

The wireless communication network 1 comprises a radio network node 12 providing radio coverage over a geographical area, a service area 11, of a radio access technology (RAT), such as a satellite communication system, LTE, Wi-Fi, WiMAX or similar. The radio network node 12 may be a transmission and reception point e.g. a network node such as a satellite, a Wireless Local Area Network (WLAN) access point or an Access Point Station (AP STA), an access node, an access controller, a base station, e.g. a radio base station such as a NodeB, an evolved Node B (eNB, eNodeB), a gNodeB (gNB), a base transceiver station, a radio remote unit, an Access Point Base Station, a base station router, a transmission arrangement of a radio base station, a stand-alone access point or any other network unit or node capable of communicating with a UE within the area served by the radio network node 12 depending e.g. on the radio access technology and terminology used. The radio network node 12 may alternatively or additionally be a controller node or a packet processing node or similar. The radio network node 12 may be referred to as a serving network node wherein the service area 11 may be referred to as a serving cell or primary cell, and the serving network node communicates with the UE 10 in form of DL transmissions to the UE 10 and UL transmissions from the UE 10. It should be noted that the radio network node 12 providing the configuration to the UE 10 may be the serving but may also be a non-serving radio network node.

It should be noted that a service area may be denoted as cell, beam, beam group or similar to define an area of radio coverage.

According to embodiments herein when a triggering event occurs, that is, when a condition is fulfilled, the UE 10 initiates a timer, which may be a first and/or a second timer (may be the same timer). The timer may be associated with an RTT and during or while running, i.e. the duration, of the timer the UE 10 is not allowed to monitor a control channel such as the PDCCH. The RTT is the time for sending data between the radio network node 12, serving the UE 10, and the UE 10 e.g. a time for sending data over a forward link and a return link. Upon expiry of the timer the UE 10 activates monitoring of the control channel for a response or data related to the triggering event such as SR response or message 3 (msg 3). A triggering event is related to a communication between the radio network node 12 and the UE 10, such as an action or occurrence related to scheduling of resources. The triggering event may be one or more of the following: transmitting an SR to the radio network node 12; sending a PDSCH message such as Message 3 (msg3) scheduled by a RAR grant; and receiving a Random Access Response (RAR) from the radio network node 12 e.g. reception of a RAR for a Random Access Preamble not selected by a MAC entity among the contention-based Random Access Preamble. It should be noted that the UE 10 may obtain an indication associated with the RTT from the radio network node 12 or from another radio network node, or be preconfigured with the RTT.

Note that in a general scenario the term “radio network node” can be substituted with “transmission point”. Distinction between the transmission points (TPs) may typically be based on cell specific reference signals (CRS) or different synchronization signals transmitted. Several TPs may be logically connected to the same radio network node but if they are geographically separated, or are pointing in different propagation directions, the TPs may be subject to the same mobility issues as different radio network nodes. In subsequent sections, the terms “radio network node” and “TP” can be thought of as interchangeable.

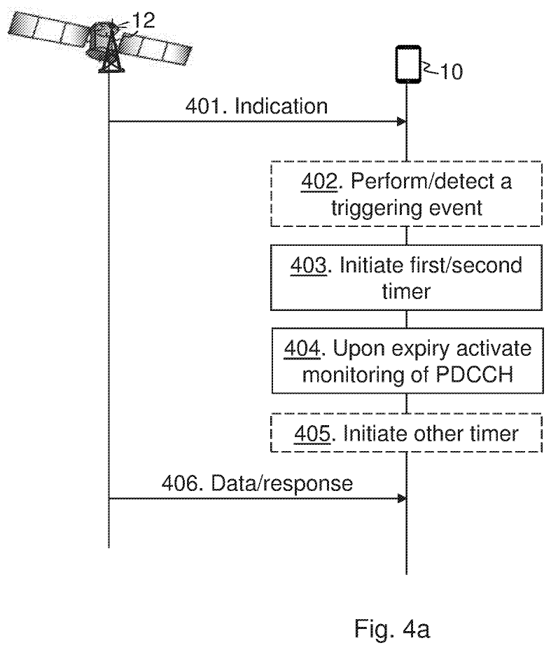

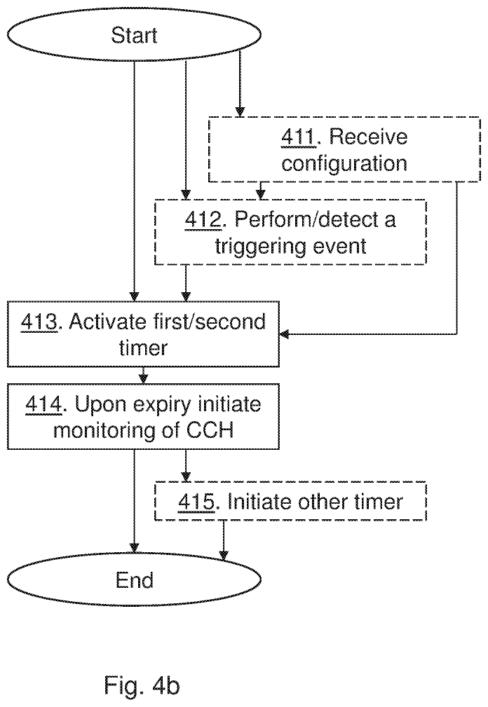

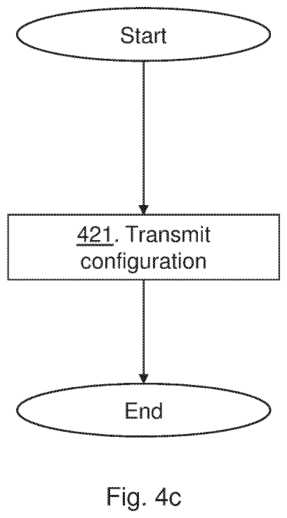

FIG. 4a is a combined flowchart and signalling scheme according to some embodiments herein. The actions may be performed in any suitable order. Dashed boxes indicate that these action may be optional.

Action 401. The radio network node 12 or another network node may transmit the indication to the UE 10, wherein the indication may indicate the timer to use, the value of the timer and/or a RTT between the radio network node serving the UE 10, and the UE 10. Thus, the UE 10 may obtain information relating to: one or more timers such as the first and/or the second timer; which timer to use; value of the one or more timers; RTT between the radio network node 12 and the UE 10; and/or timer or timer value of the other timer such as a timer indicating interval for monitoring the control channel e.g. ‘onduration’-timer. The UE 10 may obtain the information such as the indication and/or configuration from the serving radio network node, be preconfigured, or from another network node.

Action 402. The UE 10 detects or performs the triggering event such as transmitting an SR to the radio network node 12, sending the PDSCH message such as Message 3 (msg3) scheduled by the RAR grant, or receiving a RAR from the radio network node 12. For example, the UE 10 knows that it will not receive PDCCH until the RTT between the radio network node 12 and the UE 10 (plus time offset between the reception of the RAR and the transmission of the PUSCH scheduled by the RAR) has elapsed.

Action 403. The UE 10, upon occurrence of the triggering event, initiates or activates the timer such as the first timer in case of scheduling request and/or the second timer upon reception of the RAR from the radio network node 12. During the interval of the timer the UE 10 is allowed to not monitor the control channel for one or more transmissions from the radio network node 12. Thus, the UE 10 may upon occurrence of the triggering event discontinuously monitor the control channel by using an offset to delay activation of the monitoring.

Action 404. Upon expiry of the timer, the UE 10 then activates monitoring of the control channel such as the PDCCH for one or more transmissions from the radio network node 12.

Action 405. The UE 10 may additionally activate or initiate another timer such as a duration timer, during which the UE monitors for one or more transmissions from the radio network node. The other timer may thus control the time the UE 10 may monitor the control channel for a specific SR response. When this timer expires, the UE should stop monitoring the PDCCH for this particular SR response.

Action 406. The radio network node 12 may transmit the SR response to the SR, or data such as Msg3 response on the shared or control channel as indicated by the received RAR and the UE 10 may receive the same.

Embodiments herein provide options to allow the UE 10 to monitor the control channel, exemplified herein as the PDCCH, discontinuously when the propagation delay in the system is large. This allows the UE 10 to save energy and the battery lifetime can be extended.

The method actions performed by the UE 10 for managing monitoring of a control channel, e.g. for transmissions, from the radio network node 12 according to embodiments will now be described with reference to a flowchart depicted in FIG. 4b. The actions do not have to be taken in the order as stated below, but may be taken in any suitable order. Actions performed in some embodiments are marked with dashed boxes.

Action 411. The UE may receive a configuration for configuring the UE 10 to apply the timer, wherein the configuration indicates: a value of the timer, a timer to use and/or a round trip time (RTT) between the radio network node and the UE. The UE may thus be informed of the RTT to the radio network node 12, and the timer may be based on the RTT. The configuration may indicate that the UE 10 should use the timer to avoid monitoring the control channel.

Action 412. The UE 10 may detect or perform the triggering event such as transmitting the SR, receiving the RAR, or sending the PDSCH message scheduled by the RAR grant. For example, receiving the RAR for the RA Preamble not selected by the MAC entity among the contention-based Random Access Preamble (or transmitting in accordance with the RAR).

Action 413. The UE 10 activates, upon detection of the triggering event occurrence, the timer, wherein the triggering event occurrence comprises transmitting the scheduling request and/or receiving the RAR. The timer may be a first timer in case of transmission of the scheduling request, and may be a second timer upon reception, from the radio network node 12, of the RAR for a Random Access Preamble not selected by a MAC entity among a contention-based Random Access Preamble, or upon sending the PDSCH message scheduled by the RAR grant. The timer defines an interval allowing the UE not to monitor the control channel being a PDCCH. Thus, the timer delays the UE to start monitoring the control channel.

Action 414. The UE 10 initiates, upon expiry of the timer, a monitoring of the control channel for one or more transmissions from the radio network node 12.

Action 415. The UE 10 may initiate another timer upon starting the monitoring of the control channel, thus, the UE may stay in (continue) monitoring the control channel during the other timer that is triggered upon initiating the monitoring of the control channel.

The method performed by the radio network node 12 for handling or managing monitoring of the control channel in the wireless communication network according to embodiments will now be described with reference to a flowchart depicted in FIG. 4c.

Action 421. The radio network node transmits the configuration for configuring the UE to apply the timer, upon knowledge of RTT between the radio network node and the UE, wherein the configuration indicates the value of the timer, the timer to use and/or the RTT between the radio network node and the UE. The configuration may comprise information regarding one or more of: one or more timers; which timer to use; value of the one or more timers; RTT between the radio network node and the UE 10; and/or timer or timer value of another timer indicating interval for monitoring the control channel.

Case 1: Embodiments herein allow the UE 10 not to monitor the PDCCH continuously when a scheduling request is pending until a time period of RTT has elapsed.

The UE 10 knows that it will not receive a PDCCH responding to its scheduling request until the RTT between the UE 10 and radio network node 12 has elapsed. The UE 10 may thus offset the start of its active time i.e. when to activate monitoring of the PDCCH. The UE 10 may be informed of the RTT of the current serving cell by the indication, e.g. in system information (SI) or in RRC configuration, and may then start the timer, also referred to as the first timer, to delay the start of the active time which is the time when the UE 10 starts to actively monitor the PDCCH. An example name of such a timer may be e.g. drx-SR-RTT-Timer.

When the timer expires and the UE 10 enters active time i.e. time to monitor the control channel, it should then start the other timer to control the time the UE 10 monitors the PDCCH for a specific SR response. When this other timer expires, the UE 10 should stop monitoring the PDCCH for this particular SR response. As one implementation possibility, the onDurationTimer is reused and started when the timer such as the drx-SR-RTT-Timer expires.

In current procedures, there can be multiple SRs being sent either due to, for example, the periodicity of SR-transmissions being lower than RTT or that more data arrives on different logical channels. To deal with the timer, multiple instances of the timer may be generated and upon expiry the action is the same as above. In a sub-embodiment, the number of timers generated may be limited to allow for a more straightforward implementation.

Additionally or alternatively, the UE 10 may start the timer only for the first SR triggered and upon expiry the action is as above. An example of how this can be used is that a set of SRs are sent close in time so that the network has a higher probability of receiving the SRs and then the UE 10 will wake up after RTT milliseconds for monitoring PDCCH responding to any of the SRs sent.

Case2: Embodiments herein may allow the UE 10 not to monitor the PDCCH continuously after successful reception of a Random Access Response for the Random Access Preamble not selected by the MAC entity among the contention-based Random Access Preamble, or after sending the PDSCH message scheduled by the RAR grant.

Given that the PUSCH scheduled by the RAR grant acts as acknowledgement (ACK) for the RAR, the UE may assume that the network does not transmit PDCCH until the network has received the PUSCH scheduled by the RAR grant. From the UE's perspective, the UE 10 knows that it will not receive PDCCH until the RTT between the radio network node 12 and the UE 10 (plus time offset between the reception of the RAR and the transmission of the PUSCH scheduled by the RAR) has elapsed. The UE 10 can thus delay the start of its active time, e.g. the second timer. The UE 10 may be informed of the RTT of the current serving cell, e.g. by an indication in SI or RRC configuration, and can then start the second timer to delay the entering of the active time, which is the time when the UE 10 starts to actively monitor the PDCCH. The example name of such a second timer may be drx-CFRA-RTT-Timer.

When the second timer expires and the UE 10 enters active time, the UE 10 may then start another timer to control the time the UE monitors the PDCCH. When this other timer expires, the UE 10 may stop monitoring the PDCCH. As one implementation possibility, the onDurationTimer is reused as the other timer and started when the second timer expires.

Embodiments herein may allow the UE 10 to be momentarily reachable after sending SR (Case 1) or, after successful reception of a Random Access Response for the Random Access Preamble not selected by the MAC entity among the contention-based Random Access Preambles (Case 2), so that UE 10 may still be reachable during the period. The advantage of this is that in case the radio network node 12 is late in scheduling the UE 10, the UE 10 may still be contacted.

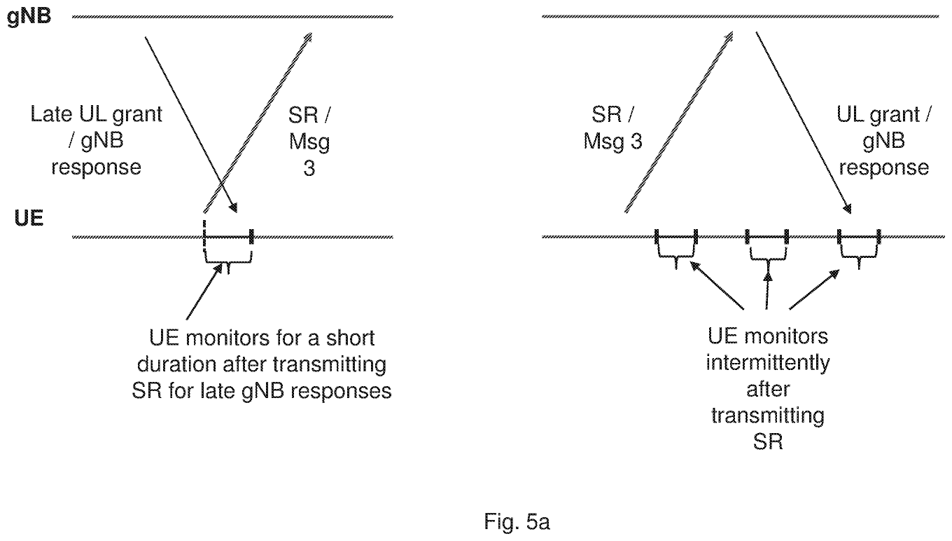

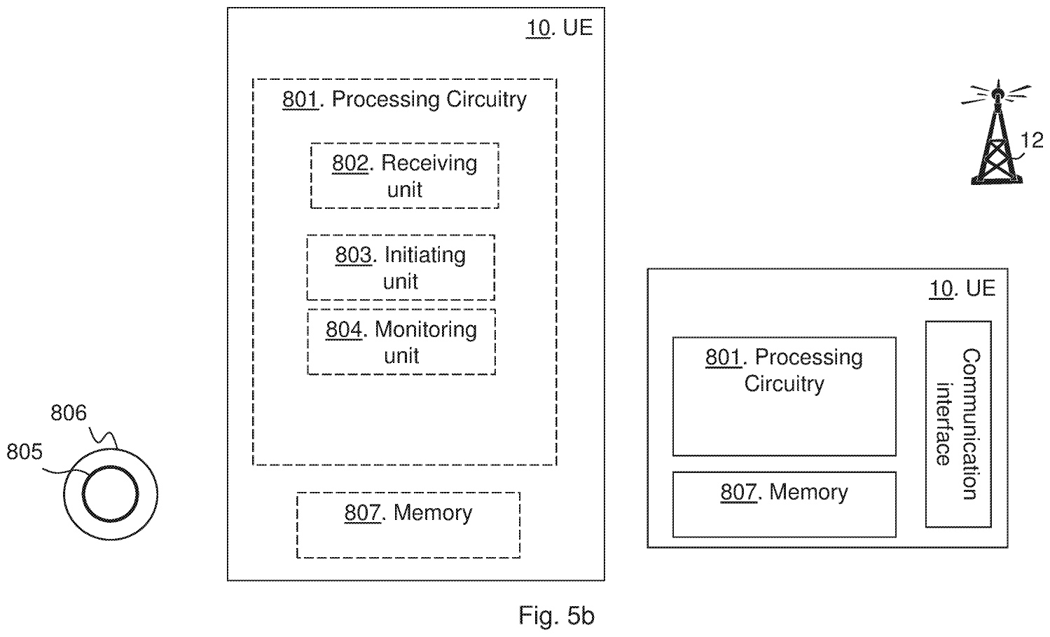

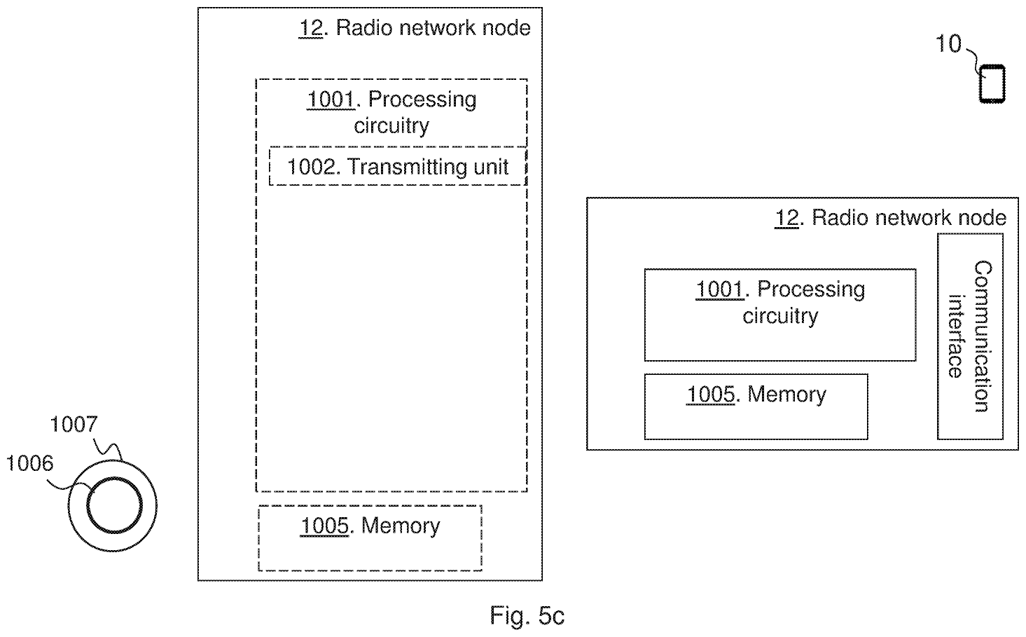

Additionally or alternatively, in the Case 1 or Case 2 the UE 10 may be momentarily reachable by having the UE 10 to stay in active time for a period to make sure that the UE 10 may receive PDCCH, such as late UL grants. This can be done by introducing another timer that is triggered directly after Case 1 or Case 2. When the other timer is running, the UE 10 monitors the PDCCH. An example of this can be seen in FIG. 5a. An example of a name for this other timer may be drx-NTNRTTTimerOffset.

Additionally or alternatively, after sending SR (Case 1) or after successful reception of a Random Access Response for the Random Access Preamble not selected by the MAC entity among the contention-based Random Access Preamble (Case 2), the UE 10 is momentarily reachable by utilizing the current Rel-15 DRX procedure. An example of this can be seen in FIG. 5a. FIG. 5a a) shows the example of having a timer to make it possible to reach the UE directly after sending the SR/PUSCH message (Case 1 or Case 2). and FIG. 5a_b) shows the example of having a timer to make it possible to periodically reach the UE 10 directly after sending the SR/PUSCH message (Case 1 or Case 2).

Configuring options comprise the following. For configuring the introduced timers mentioned above:
The value of the timers i.e. the first and second timers (drx-SR-RTT-Timer, drx-CFRA-RTT-Timer) may be signalled by:
   broadcast,
   UE-specific,
   Hardcoded in the specification,
   Calculated as a fraction of the RTT
      As an example: drx-SR-RTT-Timer can be configured to be an ⅛ of the RTT.
Whether the UE 10 shall use these timers may be signalled by means of MAC control element (CE).

One example of how to implement the signalling is shown below where the two timers drx-SR-RTT-Timer, drx-CFRA-RTT-Timer are signalled as a single timer and a Boolean value may be used to configure whether any of them will be applied.

DRX-Config

The information element (IE) DRX-Config is used to configure DRX related parameters. Underlined matters are added text according to embodiments herein.

### DRX-Config Information Element

| -- ASN1START | | |
|---|---|---|
| -- TAG-DRX-CONFIG-START | | |
| DRX-Config : := | SEQUENCE { | |
| drx-onDurationTimer | CHOICE { | |
| | subMilliSeconds INTEGER (1..31), | |
| | milliseconds ENUMERATED { | |
| | ms1, ms2, ms3, ms4, ms5, ms6, ms8, ms10, | |
| ms20, ms30, ms40, ms50, ms60, | | |
| | ms80, ms100, ms200, ms300, ms400, ms500, | |
| ms600, ms800, ms1000, ms1200, | | |
| | ms1600, spare8, spare7, spare6, spare5, | |
| spare4, spare3, spare2, spare1 } | | |
| | }, | |
| drx-InactivityTimer | ENUMERATED { | |
| | ms0, ms1, ms2, ms3, ms4, ms5, ms6, ms8, ms10, | |
| ms20, ms30, ms40, ms50, ms60, ms80, | | |
| | ms100, ms200, ms300, ms500, ms750, ms1280, | |
| ms1920, ms2560, spare9, spare8, | | |
| | spare7, spare6, spare5, spare4, spare3, spare2, | |
| spare1}, | | |
| drx-HARQ-RTT-TimerDC | INTEGER (0..56), | |
| drx-HARQ-RTT-TimerUL | INTEGER (0..56), | |
| drx-RetransmissionTimerDL | ENUMERATED { | |
| | s10, s11, s12, s14, s16, s18, s116, s124, s133, | |
| s140, s164, s180, s196, s1112, s1128, | | |
| | s1160, s1320, spare15, spare14, spare13, | |
| spare12, spare11, spare10, spared9, | | |
| | spare8, spare7, spare6, spare5, spare4, spare3, | |
| spare2, spare1}, | | |
| drx-RetransmissionTimerUL | ENUMERATED { | |
| | s10, s11, s12, s14, s16, s18, s116, s124, s133, | |
| s140, s164, s180, s196, s1112, s1128, | | |
| | s1160, s1320, spare15, spare14, spare13, | |
| spare12, spare11, spare10, spared9, | | |
| | spare8, spare7, spare6, spare5, spare4, spare3, | |
| spare2, spare1 }, | | |
| drx-LongCyclestartOffset | CHOICE { | |
| ms10 | INTEGER (0..9), | |
| ms20 | INTEGER (0..19), | |
| ms32 | INTEGER (0..31), | |
| ms40 | INTEGER (0..39), | |
| ms60 | INTEGER (0..59), | |
| ms64 | INTEGER (0..63), | |
| ms70 | INTEGER (0..69), | |
| ms80 | INTEGER (0..79), | |
| ms128 | INTEGER (0..127), | |
| ms160 | INTEGER (0..159), | |
| ms256 | INTEGER (0..255), | |
| ms320 | INTEGER (0..319), | |
| ms512 | INTEGER (0. 511), | |
| ms640 | INTEGER (0..639), | |
| ms1024 | INTEGER (0..1023), | |
| ms1280 | INTEGER (0..1279), | |
| ms2048 | INTEGER (0..2047), | |
| ms2560 | INTEGER (0..2559), | |
| ms5120 | INTEGER (0..5119), | |
| ms10240 | INTEGER (0..10239) | |
| }, | | |
| shortDRX | SEQUENCE { | |
| drx-ShortCycle | ENUMERATED { | |
| | ms2, ms3, ms4, ms5, ms6, ms7, ms8, ms10, | |
| ms14, ms16, ms20, ms30, ms32, | | |
| | ms35, ms40, ms64, ms80, ms128, ms160, | |
| ms256, ms320, ms512, ms640, spare9, | | |
| | spare8, spare7, spare6, spare5, spare4, | |
| spare3, spare2, spare1 }, | | |
| drx-ShortCycleTimer | INTEGER (1..16) | |
| } | | |
| OPTIONAL, -- Need R | | |
| drx-SlotOffset | INTEGER (0..31) | |
| } | | |
| DRX-Confiq-v1630 : := | SEQUENCE { | |
| drx-SR-CFRA-RTT-Timer | CHOICE { | |
| rtt | NULL, | |
| non-rtt | ENUMERATED { | |
| | ms10, ms20, ms 32, ms40, | |
| | ms60, ms64, ms70, ms80, | |
| | ms128, ms160, ms256, ms320 | |
| | ms512} | OPTIONAL, |
| drx-SR-CFRA-applied | SEQUENCE { | |
| SR | BOOLEAN, | |
| cfra | BOOLEAN, | |
| }, | | OPTIONAL, |
| drx-NTNRTTTimerOffset | ENUMERATED { | |
| | ms10, ms20, ms 32, ms40, | |
| | ms60, ms64, ms70, ms80, | |
| | ms128, ms160, ms256, ms320 | |
| | ms512} | OPTIONAL, |
| } | | |
| -- TAG-DRX-CONFIG-STOP | | |
| -- ASN1STOP | | |

DRX-Config field descriptions

drx-HARQ-RTT-TimerDL
Value in number of symbols of the BWP where the transport block was received.
drx-HARQ-RTT-TimerUL
Value in number of symbols of the BWP where the transport block was transmitted.
drx-InactivityTimer
Value in multiple integers of 1 ms. ms0 corresponds to 0, ms1 corresponds to 1 ms,
ms2 corresponds to 2 ms, and so on.
drx-LongCycleStartOffset
drx-LongCycle in ms and drx-StartOffset in multiples of 1 ms. If drx-ShortCycle is configured,
the value of drx-LongCycle shall be a multiple of the drx-ShortCycle value.
drx-onDurationTimer
Value in multiples of 1/32 ms (subMilliSeconds) or in ms (milliSecond). For the latter,
value ms1 corresponds to 1 ms, value ms2 corresponds to 2 ms, and so on.
drx-RetransmissionTimerDL
Value in number of slot lengths of the BWP where the transport block was received. value sl0
corresponds to 0 slots, sl1 corresponds to 1 slot, sl2 corresponds to 2 slots, and so on.
drx-RetransmissionTimerUL
Value in number of slot lengths of the BWP where the transport block was transmitted. sl0
corresponds to 0 slots, sl1 corresponds to 1 slot, sl2 corresponds to 2 slots, and so on.
drx-ShortCycleTimer
Value in multiples of drx-ShortCycle. A value of 1 corresponds to drx-ShortCycle,
a value of 2 corresponds to 2 * drx-ShortCycle and so on.
drx-ShortCycle
Value in ms. ms1 corresponds to 1 ms, ms2 corresponds to 2 ms, and so on.
drx-SlotOffset
Value in 1/32 ms. Value 0 corresponds to 0 ms, value 1 corresponds to 1/32 ms,
value 2 corresponds to 2/32 ms, and so on.
DRX-SR-CFRA-applied
Indicates the applicability of DRX-SR-CFRA-RTT-timer. If DRX-SR-CFRA-RTT-timer is absent,
UE applies a values given in system information. If the field is set to “SR”, UE applies
DRX-SR-CFRA-RTT-timer after sending scheduling request. If the field is set to “cfra”,
UE applies DRX-SR-CFRA-RTT-timer after sending its PUSCH message scheduled by
RAR UL grant. If the field is set to both, UE applies DRX-SR-CFRA-RTT-timer after
sending both its PUSCH message scheduled by RAR UL grant, and SR.
DRX-SR-CFRA-RTT-timer
Value in ms for UE not monitoring PDCCH. If the value RTT is applied, then the
UE will use the UE-internal variable RTT.
DRX-NTNRTTTimerOffset
Value in ms for UE not monitoring PDCCH after SR or PUSCH message scheduled by RAR
UL grant.

FIG. 5b is a block diagram depicting the UE 10 for handling communication e.g. for managing monitoring of the control channel from the radio network node (12) according to embodiments herein.

The UE 10 may comprise processing circuitry 801, e.g. one or more processors, configured to perform the methods herein.

The UE 10 may comprise a receiving unit 802, e.g. a receiver or a transceiver. The UE 10, the processing circuitry 801, and/or the receiving unit 802 may be configured to obtain the indication e.g. receive the indication from the radio network node 12, obtain internally from a pre-configuration, or receive from another radio network node. The indication may indicate to use the timer or a value of the timer such as the first/second timer. The indication may e.g. be a configuration from the radio network node 12 indicating usage of the timer upon knowledge of RTT above a set threshold, or a timer value related to RTT. The UE 10, the processing circuitry 801, and/or the receiving unit 802 may be configured to obtain the RTT between the radio network node and the UE 10. The RTT may be indicated, for example by the indication, and may be a real value, an index value or similar. The RTT may be obtained from the radio network node 12 or another radio network node or may be preconfigured. Thus, the UE 10, the processing circuitry 801, and/or the receiving unit 802 may be configured to be informed of the RTT to the radio network node 12, and the timer may be based on the RTT. The UE 10, the processing circuitry 801, and/or the receiving unit 802 may be configured to receive the configuration for configuring the UE to apply the timer, wherein the configuration indicates the value of the timer, the timer to use and/or the RTT between the radio network node and the UE.

The UE 10 may comprise an initiating unit 803. The UE 10, the processing circuitry 801, and/or the initiating unit 803 is configured to, upon detection of occurrence of the triggering event also denoted as triggering event occurrence, activate the timer such as the first and/or the second timer. The triggering event occurrence comprises transmitting a scheduling request, receiving the RAR, or sending the PDSCH message scheduled by the RAR grant. The timer may comprise a set interval during which the UE is not allowed to monitor the control channel such as the PDCCH for one or more transmissions from the radio network node 12. The timer may be the first timer in case of transmission of the scheduling request, and/or the second timer upon reception, from the radio network node 12, of the RAR for a Random Access Preamble not selected by a MAC entity among a contention-based Random Access Preamble, or upon sending the PDSCH message scheduled by the RAR grant. The timer may define the interval allowing the UE not to monitor the control channel being a PDCCH.

The UE 10 may further comprise a monitoring unit 804. The UE 10, the processing circuitry 801, and/or the monitoring unit 804 is configured to initiate, upon expiry of the timer, the monitoring of the control channel for one or more transmissions from the radio network node. Thus, the UE 10, the processing circuitry 801, and/or the monitoring unit 804 may be configured to monitor, upon expiry of the timer, the control channel for one or more transmissions from the radio network node 12. The monitoring may be performed during the interval of the other timer. The UE 10, the processing circuitry 801, and/or the monitoring unit 804 may be configured to stay in monitoring the control channel during the other timer that is triggered upon initiating the monitoring of the control channel.

The UE 10 further comprises a memory 807. The memory comprises one or more units to be used to store data on, such as control channel information, SR, RAR, indications, RSs, strengths or qualities, UL grants, indications, requests, commands, timers, applications to perform the methods disclosed herein when being executed, and similar. The UE 10 comprises a communication interface comprising one or more antennas.

The methods according to the embodiments described herein for the UE 10 are respectively implemented by means of, for example, a computer program product 805 or a computer program, comprising instructions, i.e., software code portions, which, when executed on at least one processor, cause the at least one processor to carry out the actions described herein, as performed by the UE 10. The computer program product 805 may be stored on a computer-readable storage medium 806, e.g. a universal serial bus (USB) stick, a disc or similar. The computer-readable storage medium 806, having stored thereon the computer program product, may comprise the instructions which, when executed on at least one processor, cause the at least one processor to carry out the actions described herein, as performed by the UE 10. In some embodiments, the computer-readable storage medium may be a non-transitory or a transitory computer-readable storage medium.

FIG. 5c is a block diagram depicting the radio network node 12 for handling, e.g. facilitating, monitoring of the control channel in the wireless communication network sucg as handling configuration in the wireless communication network 1 according to embodiments herein.

The radio network node 12 may comprise processing circuitry 1001, e.g. one or more processors, configured to perform the methods herein.

The radio network node 12 may comprise a transmitting unit 1002, e.g. a transmitting or a transceiver. The radio network node 12, the processing circuitry 1001 and/or the transmitting unit 1002 is configured to transmit the configuration for configuring the UE to apply the timer, upon knowledge of the RTT between the radio network node and the UE, wherein the configuration indicates the value of the timer, the timer to use and/or the RTT between the radio network node and the UE. The configuration may comprise information regarding one or more of: one or more timers; which timer to use; value of the one or more timers; RTT between the radio network node and the UE 10; and/or timer or timer value of another timer indicating interval for monitoring the control channel. The radio network node 12, the processing circuitry 1001 and/or the transmitting unit 1002 may be configured to transmit one or more indications to the UE 10. The one or more indications may indicate timer to use or a value of the timer such as the first/second timer. The indication may e.g. be a configuration from the radio network node 12 indicating usage of the timer upon knowledge of RTT above a set threshold, or a timer value related to RTT. The configuration may comprise indication that the UE 10 should use the timer to avoid monitoring the control channel during the timer interval.

The radio network node 12 further comprises a memory 1005. The memory comprises one or more units to be used to store data on, such as indications, strengths or qualities, grants, RAR, SR, scheduling information, timers, applications to perform the methods disclosed herein when being executed, and similar. The radio network node 12 comprises a communication interface comprising transmitter, receiver, transceiver and/or one or more antennas.

The methods according to the embodiments described herein for radio network node 12 are respectively implemented by means of, for example, a computer program product 1006 or a computer program product, comprising instructions, i.e., software code portions, which, when executed on at least one processor, cause the at least one processor to carry out the actions described herein, as performed by the first radio network node 12. The computer program product 1006 may be stored on a computer-readable storage medium 1007, e.g. a USB stick, a disc or similar. The computer-readable storage medium 1007, having stored thereon the computer program product, may comprise the instructions which, when executed on at least one processor, cause the at least one processor to carry out the actions described herein, as performed by the radio network node 12. In some embodiments, the computer-readable storage medium may be a non-transitory or transitory computer-readable storage medium.

In some embodiments a more general term “radio network node” is used and it can correspond to any type of radio network node or any network node, which communicates with a wireless device and/or with another network node. Examples of network nodes are NodeB, Master eNB, Secondary eNB, a network node belonging to Master cell group (MCG) or Secondary Cell Group (SCG), base station (BS), multi-standard radio (MSR) radio node such as MSR BS, eNodeB, network controller, radio network controller (RNC), base station controller (BSC), relay, donor node controlling relay, base transceiver station (BTS), access point (AP), transmission points, transmission nodes, Remote Radio Unit (RRU), Remote Radio Head (RRH), nodes in distributed antenna system (DAS), core network node e.g. Mobility Switching Centre (MSC), Mobile Management Entity (MME) etc., Operation and Maintenance (O&M), Operation Support System (OSS), Self-Organizing Network (SON), positioning node e.g. Evolved Serving Mobile Location Centre (E-SMLC), Minimizing Drive Test (MDT) etc.

In some embodiments the non-limiting term wireless device or user equipment (UE) is used and it refers to any type of wireless device communicating with a network node and/or with another UE in a cellular or mobile communication system. Examples of UE are target device, device-to-device (D2D) UE, proximity capable UE (aka ProSe UE), machine type UE or UE capable of machine to machine (M2M) communication, PDA, PAD, Tablet, mobile terminals, smart phone, laptop embedded equipped (LEE), laptop mounted equipment (LME), USB dongles etc.

The embodiments are described for 5G. However the embodiments are applicable to any RAT or multi-RAT systems, where the UE receives and/or transmit signals (e.g. data) e.g. LTE, LTE FDD/TDD, WCDMA/HSPA, GSM/GERAN, Wi Fi, WLAN, CDMA2000 etc.

As will be readily understood by those familiar with communications design, that functions or modules may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of communications devices will appreciate the cost, performance, and maintenance trade-offs inherent in these design choices.

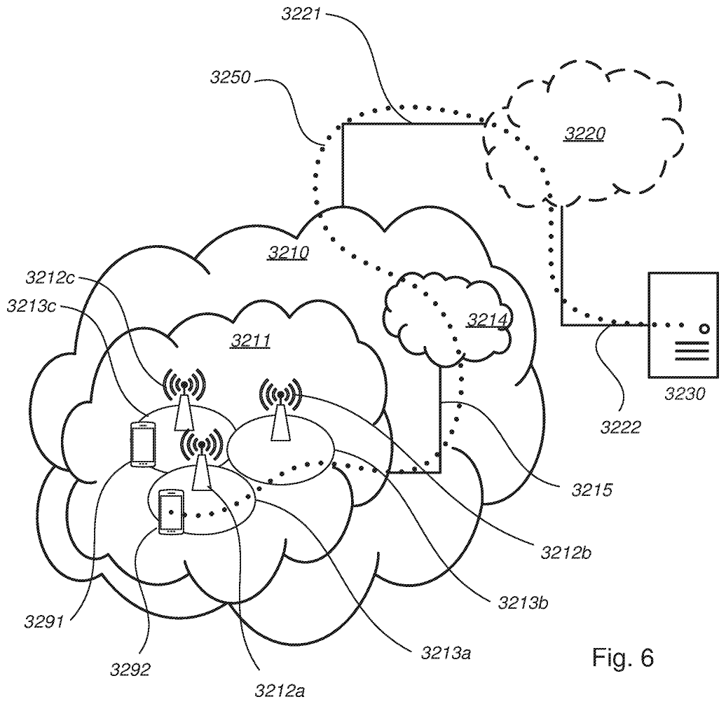

With reference to FIG. 6, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points being examples of the radio network node 12 herein, each defining a corresponding coverage area 3213a, 3213b, 3213c. Each base station 3212a, 3212b, 3212c is connectable to the core network 3214 over a wired or wireless connection 3215. A first user equipment (UE) 3291, being an example of the UE 10, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 6 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

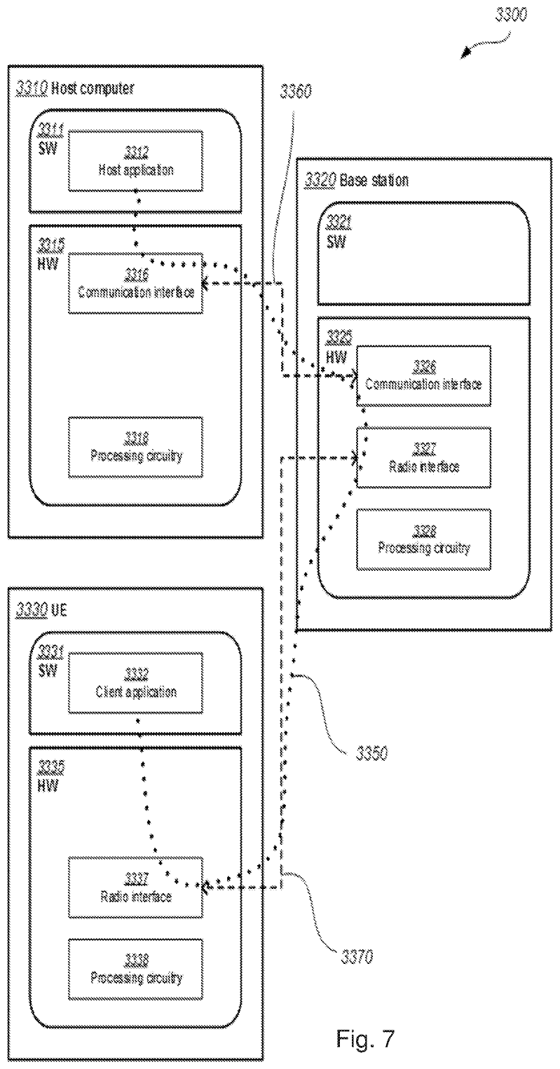

Example implementations, in accordance with an embodiment, of the UE, base station and host computer discussed in the preceding paragraphs will now be described with reference to FIG. 7. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 7) served by the base station 3320. The communication interface 3326 may be configured to facilitate a connection 3360 to the host computer 3310. The connection 3360 may be direct or it may pass through a core network (not shown in FIG. 7) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 7 may be identical to the host computer 3230, one of the base stations 3212a, 3212b, 3212c and one of the UEs 3291, 3292 of FIG. 6, respectively. This is to say, the inner workings of these entities may be as shown in FIG. 7 and independently, the surrounding network topology may be that of FIG. 6.

In FIG. 7, the OTT connection 3350 has been drawn abstractly to illustrate the communication between the host computer 3310 and the user equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the energy consumption of the UE and thereby provide benefits such as improved battery time, and better responsiveness.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

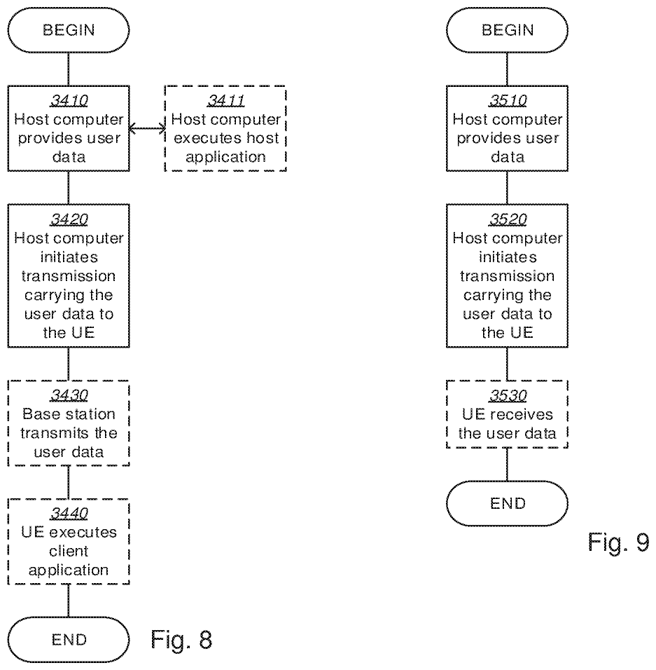

FIG. 8 is a flowchart illustrating a method implemented in a communication system, in accordance with one embodiment. The communication system includes a host computer, a base station and a UE which may be those described with reference to FIGS. 6 and 7. For simplicity of the present disclosure, only drawing references to FIG. 8 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 9 is a flowchart illustrating a method implemented in a communication system, in accordance with one embodiment. The communication system includes a host computer, a base station and a UE which may be those described with reference to FIGS. 6 and 7. For simplicity of the present disclosure, only drawing references to FIG. 9 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

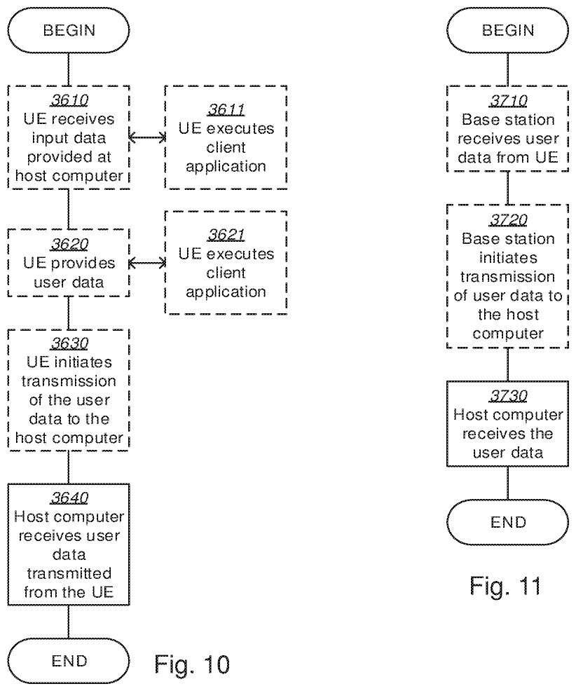

FIG. 10 is a flowchart illustrating a method implemented in a communication system, in accordance with one embodiment. The communication system includes a host computer, a base station and a UE which may be those described with reference to FIGS. 6 and 7. For simplicity of the present disclosure, only drawing references to FIG. 10 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 11 is a flowchart illustrating a method implemented in a communication system, in accordance with one embodiment. The communication system includes a host computer, a base station and a UE which may be those described with reference to FIGS. 6 and 7. For simplicity of the present disclosure, only drawing references to FIG. 11 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

Modifications and other embodiments of the disclosed embodiments will come to mind to one skilled in the art having the benefit of the teachings presented in the foregoing descriptions and the associated drawings. Therefore, it is to be understood that the embodiment(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

Abbreviations

ACK Acknowledged

ADC Analog-to-digital conversion

AGC Automatic gain control

ANR Automatic neighbour relations

AP Access point

BCH Broadcast channel

BLER Block error rate

BRS Beam Reference Signal

BS Base station

BSC Base station controller

BTS Base transceiver station

CA Carrier aggregation

CC Component carrier

CG Cell group

CGI Cell global identity

CP Cyclic prefix

CPICH Common pilot channel

CQI Channel Quality Indicator

CSG Closed subscriber group

CSI-RS Channel State Information Reference Signal

DAS Distributed antenna system

DC Dual connectivity

DFT Discrete Fourier Transform

DL Downlink

DL-SCH Downlink shared channel

DRX Discontinuous reception

EARFCN Evolved absolute radio frequency channel number

ECGI Evolved CGI

eNB eNodeB

FDD Frequency division duplex

FFT Fast Fourier transform

HD-FDD Half duplex FDD

HO Handover

ID Identity

M2M machine to machine

MAC Media access control

MCG Master cell group

MDT Minimization of drive tests

MeNB Master eNode B

MIB Master information block

MME Mobility management entity

MRS Mobility Reference Signal

MRTD Maximum receive timing difference

MSR Multi-standard radio

NACK Not acknowledged

OFDM Orthogonal frequency-division multiplexing

RI Rank Indicator

SI System Information

PCC Primary component carrier

PCI Physical cell identity

PCell Primary Cell

PCG Primary Cell Group

PCH Paging channel

PDU Protocol data unit

PGW Packet gateway

PHICH Physical HARQ indication channel

PLMN Public land mobile network

PMI Precoding Matrix Indicator

PSCell Primary SCell

PSC Primary serving cell

PSS Primary synchronization signal

RAT Radio access Technology

RF Radio frequency

RLM Radio link monitoring

RNC Radio network Controller

RRC Radio resource control

RRH Remote radio head

RRU Remote radio unit

RSCP Received signal code power

RSRP Reference Signal Received Power

RSRQ Reference Signal Received Quality

RSSI Received signal strength indication

RSTD Reference signal time difference

RV Redundancy version

Rx Receiver

SCC Secondary component carrier

SCell Secondary Cell

SCG Secondary Cell Group

SeNB Secondary eNode B

SFN System frame number

SGW Signalling gateway

SI System information

SIB System information block

SIB1 System information block type 1

SINR Signal to interference and noise ratio

SON Self-organizing networks

SSC Secondary serving cell

SSS Secondary synchronization signal

TA Timing advance

TAG Timing advance group

TDD Time division duplex

Tx Transmitter

UARFCN UMTS Absolute Radio Frequency Channel Number

UE User equipment

UL Uplink

1-18. (canceled)

19. A method performed by a user equipment (UE) for managing monitoring of a control channel from a radio network node, the method comprising:
activating, upon detection of a triggering event occurrence, a timer, wherein the triggering event occurrence comprises transmitting a scheduling request, receiving a random access response (RAR), and sending a physical uplink shared channel (PUSCH) message scheduled by a RAR grant; and
initiating, upon expiry of the timer, a monitoring of the control channel for one or more transmissions from the radio network node.

20. The method according to claim 19, wherein the timer is a first timer in case of transmission of the scheduling request, and/or a second timer upon reception, from the radio network node, of the RAR for a Random Access Preamble not selected by a MAC entity among a contention-based Random Access Preamble, or upon sending the PUSCH message scheduled by the RAR grant.

21. The method according to claim 19, wherein the timer defines an interval allowing the UE not to monitor the control channel, wherein the control channel is a physical downlink control channel (PDCCH).

22. The method according to claim 19, wherein the UE continues monitoring the control channel during another timer that is triggered upon initiating the monitoring of the control channel.

23. The method according to claim 19, wherein the UE is informed of a round trip time (RTT) to the radio network node, and the timer is based on the RTT.

24. The method according to claim 19, further comprising:
receiving a configuration for configuring the UE to apply the timer, wherein the configuration indicates a value of the timer, a timer to use and/or a round trip time (RTT) between the radio network node and the UE.

25. A method performed by a radio network node for handling monitoring of a control channel in a wireless communication network, the method comprising:
transmitting a configuration for configuring a UE to apply a timer to delay monitoring of the control channel by the UE, the delay accounting for a round trip time (RTT) between the radio network node and the UE, wherein the configuration indicates a value of the timer, a timer to use and/or the RTT between the radio network node and the UE.

26. The method according to claim 25, wherein the configuration comprises information regarding one or more of: one or more timers; which timer to use; the value of the one or more timers; the RTT between the radio network node and the UE; and/or timer or timer value of another timer indicating an interval for monitoring the control channel.

27. A user equipment (UE) for managing monitoring of a control channel from a radio network node, wherein the UE is configured to:
activate, upon detection of a triggering event occurrence, a timer, wherein the triggering event occurrence comprises transmitting a scheduling request, receiving a random access response (RAR), and sending a physical uplink shared channel (PUSCH) message scheduled by a RAR grant; and
initiate, upon expiry of the timer, a monitoring of the control channel for one or more transmissions from the radio network node.

28. The UE according to claim 27, wherein the timer is a first timer in case of transmission of a scheduling request, and/or a second timer upon reception, from the radio network node, of the RAR for a Random Access Preamble not selected by a MAC entity among a contention-based Random Access Preamble, or upon sending the PUSCH message scheduled by the RAR grant.

29. The UE according to claim 27, wherein the timer defines an interval allowing the UE not to monitor the control channel, wherein the control channel is a physical downlink control channel (PDCCH).

30. The UE according to claim 27, wherein the UE is configured to continue monitoring the control channel during another timer that is triggered upon initiating the monitoring of the control channel.

31. The UE according to claim 27, wherein the UE is informed of a round trip time (RTT) to the radio network node, and the timer is based on the RTT.

32. The UE according to claim 27, wherein the UE is configured to:
receive a configuration for configuring the UE to apply the timer, wherein the configuration indicates a value of the timer, a timer to use and/or a round trip time (RTT) between the radio network node and the UE.

33. A radio network node for handling monitoring of a control channel in a wireless communication network, wherein the radio network node is configured to:
transmit a configuration for configuring a user equipment (UE) to apply a timer to delay monitoring of the control channel by the UE, the delay accounting for a round trip time (RTT) between the radio network node and the UE, wherein the configuration indicates a value of the timer, a timer to use and/or the RTT between the radio network node and the UE.

34. The radio network node according to claim 33, wherein the configuration comprises information regarding one or more of: one or more timers; which timer to use; value of the one or more timers; RTT between the radio network node and the UE; and/or timer or timer value of another timer indicating interval for monitoring the control channel.

35. A method of operation by a User Equipment (UE) with respect to a radio network node of a wireless communication network, the method comprising:
delaying monitoring of a control channel for an expected transmission from the radio network node, according to a monitoring delay that accounts for a Round Trip Time (RTT) between the UE and the radio network node; and
commencing monitoring of the control channel upon expiry of the monitoring delay.
